(19) United States
(12) Patent Application Publication
(10) Pub. No.: US 2025/0306932 A1
(43) Pub. Date: Oct. 2, 2025

(54) Hardware Managed Synchronization of Coprocessor Instruction Execution

(71) Applicant: Tenstorrent USA, Inc., Austin, TX (US)

(72) Inventors: Syed Gilani, Markham (CA); Marco Merlini, Toronto (CA)

(21) Appl. No.: 19/014,182

(22) Filed: Jan. 8, 2025

Related U.S. Application Data
(60) Provisional application No. 63/572,259, filed on Mar. 30, 2024.
(60) Provisional application No. 63/634,461, filed on Apr. 15, 2024.

(51) Int. Cl. G06F 9/30; G06F 12/084

(52) U.S. Cl. CPC G06F 9/30058; G06F 12/084; G06F 2212/452

(57) ABSTRACT

Systems and methods related to hardware managed synchronization of coprocessor instruction execution are disclosed herein. A system may include a processor configured to generate instructions and a coprocessor configured to perform operations for the instructions. The system may also include instruction-handling circuitry within the transmission paths between the processor and the coprocessor, stall circuitry located between instruction-handling circuitry and the coprocessor, and synchronization circuitry. The synchronization circuitry may monitor the instruction-handling circuitry and may control the stall circuitry. The synchronization circuitry may be configured to selectively delay delivery of instructions at the stall circuitry based on monitoring the instruction-handling circuitry.

### CROSS REFERENCE TO RELATED APPLICATIONS

This application claims the benefit of U.S. Provisional Patent Application No. 63/572,259, filed Mar. 30, 2024, and U.S. Provisional Patent Application No. 63/634,461, filed Apr. 15, 2024, each of which are incorporated by reference herein in their entirety for all purposes.

### BACKGROUND

Many processing architectures employ a main processor supplemented by a coprocessor designed to handle specialized workloads efficiently. This architectural approach optimizes performance by offloading specific tasks from the main processor, thereby enhancing overall system efficiency. The main processor typically manages general-purpose computing tasks, while the coprocessor focuses on specialized computations such as graphics rendering, signal processing, or encryption. By distributing workloads across multiple processing units, these architectures achieve higher throughput and improved responsiveness, making them well-suited for diverse applications ranging from high-performance computing to embedded systems. Additionally, the coprocessor can often be tailored or upgraded independently, enabling flexibility and scalability in system design to meet evolving computational demands.

In certain coprocessor architectures, a processor will send two streams of instructions to the coprocessor to be executed. One stream of instructions includes computational instructions that encode specific computational tasks to be executed by the coprocessor. The other stream of instructions includes memory access instructions, which are instructions which can access the configuration registers of the coprocessor or memory that is immediately available to the computational pipeline of the coprocessor (e.g., local scratch pad registers or architectural registers). As the execution of a computational instruction will be impacted by the configuration of the processing pipeline as well as the state of the local memory of the processing pipeline as set by the memory access instructions, it is critical to keep these instruction streams synchronized.

Orchestrating the execution of memory access instructions for the coprocessor alongside the computational instructions can present challenges. In general, the synchronization of memory access instructions and computational instructions sent to a coprocessor is coordinated in the source code of the processor that sent them. For example, a programmer may need to manually enter code (e.g., a polling loop) that effectively halts the execution of computational instructions that access memory, or depend on the status of a configuration register, until any associated memory instructions which set those values in memory, or set the state of configuration registers, has been executed. This additional burden placed on the programmer makes the use of coprocessor architectures less user-friendly and generally more difficult and inefficient. Furthermore, orchestrating synchronization in hardware has been shown to improve performance as compared to standard approaches because those standard approaches (e.g., using polling) completely occupy the processor. This prevents the processor from doing useful work, wastes power, and incurs overhead from additional processor instructions. Synchronizing in hardware eliminates the waste in computational resources and power associated with those approaches.

### SUMMARY

Systems and methods related to coprocessor architectures are disclosed herein. In specific embodiments, a coprocessor architecture includes a synchronization block that handles the synchronization of computational instructions and memory access instructions in hardware so that programmers do not need to account for this synchronization when encoding workloads for the coprocessor architecture to execute. In specific embodiments, a processor and coprocessor may include two separate paths between the two processors, at least one for memory access instructions and one for computational instructions, which have different and variable delays. Accordingly, the synchronization block can sense these delays or sense when specific instructions have moved through the variable delay elements and can then delay one path or the other to enforce synchronization. In specific embodiments, there may be more than two types of instructions and more than two paths to accommodate these multiple types of instructions. The synchronization block may sense the delays of various instructions of various types to coordinate the instructions and enforce synchronization. As will be apparent to one of ordinary skill in the art upon reviewing this disclosure, the term “synchronization” is used herein to refer in the general sense to providing order to the relationship between different events and is not limited to the tighter technical definition of aligning events perfectly with respect to an external signal such as a clock.

The communication path between a processor and coprocessor may include instruction-handling circuitry such as first-in first-out (“FIFO”) buffers, architecture-specific instruction preprocessing, and the like, for example, to perform staging and arbitration operations for instructions. This circuitry could perform operations such as preparing, ordering, buffering, checking, characterizing, and/or releasing instructions to the coprocessor. In some implementations, there may be separate communication paths for computational instructions and memory access instructions, and each may have their own instruction-handling circuitry. However the instruction-handling circuitry is configured within the system, this circuitry adds delays during the transmission of instructions from the processor to the coprocessor. The synchronization block monitors information about the instructions (e.g., the progress, status, and type of instruction) in flight through the instruction-handling circuitry, for example, by snooping data directly from the instruction-handling circuitry, before the instruction-handling circuitry, and/or after the instruction-handling circuitry, to understand the instructions that are progressing through the instruction-handling circuitry and to be prepared to initiate a stall of one of the instructions when necessary to maintain integrity and ordering between memory access instructions and computational instructions.

In specific embodiments of the invention, a system for synchronizing instructions between a processor and a coprocessor is provided. The system comprises: a processor configured to generate first instructions of a first instruction type and second instructions of a second instruction type, a coprocessor configured to perform a first operation type for the first instructions and a second operation type for the second instructions, and a first instruction-handling circuitry within a first transmission path between the processor and the coprocessor, wherein the first instructions are transmitted from the processor to the coprocessor via the first instruction-handling circuitry. The system also comprises a second instruction-handling circuitry within a second transmission path between the processor and the coprocessor, wherein the second instructions are transmitted from the processor to the coprocessor via the second instruction-handling circuitry. The system also comprises: first stall circuitry located between the first instruction-handling circuitry and the coprocessor, second stall circuitry located between the second instruction-handling circuitry and the coprocessor, and synchronization circuitry coupled to monitor the first instruction-handling circuitry and the second instruction-handling circuitry and to control the first stall circuitry and the second stall circuitry, wherein the synchronization circuitry is configured to selectively delay delivery of one of the first instructions at the first stall circuitry or one of the second instructions at the second stall circuitry based on the monitoring of the first instruction-handling circuitry and the second instruction-handling circuitry.

In specific embodiments of the invention, a method for synchronizing instructions between a processor and a coprocessor is provided. The method comprises: generating, by a processor, first instructions of a first instruction type and second instructions of a second instruction type; transmitting the first instructions from the processor to a coprocessor via first instruction-handling circuitry; transmitting the second instructions from the processor to the coprocessor via second instruction-handling circuitry; monitoring, by synchronization circuitry, the first instruction-handling circuitry and the second instruction-handling circuitry; and controlling, by the synchronization circuitry and based on the monitoring, first stall circuitry and second stall circuitry, the first stall circuitry being located between the first instruction-handling circuitry and the coprocessor and the second stall circuitry being located between the second instruction-handling circuitry and the coprocessor, wherein delivery of one of the first instructions is selectively delayed at the first stall circuitry or delivery of one of the second instructions is selectively delayed at the second stall circuitry. The method further comprises performing, by the coprocessor, a first operation for the one of the first instructions and a second operation for the one of the second instructions, wherein an order of performing the first operation and performing the second operation is based on the controlling of the first stall circuitry and the second stall circuitry.

In specific embodiments of the invention, a system for synchronizing instructions between a first processor and a second processor is provided. The system comprises a first instruction-handling circuitry within a first transmission path between a first processor and a second processor, wherein a first instruction is transmitted via the first instruction-handling circuitry. The system also comprises a second instruction-handling circuitry within a second transmission path between the first processor and the second processor, wherein a second instruction is transmitted via the second instruction-handling circuitry. The system also comprises: first stall circuitry located between the first instruction-handling circuitry and the second processor, second stall circuitry located between the second instruction-handling circuitry and the second processor, and synchronization circuitry coupled to monitor the first instruction-handling circuitry and the second instruction-handling circuitry and to control the first stall circuitry and the second stall circuitry, wherein the synchronization circuitry is configured to selectively delay delivery of the first instruction at the first stall circuitry or the second instruction at the second stall circuitry based on the monitoring of the first instruction-handling circuitry and the second instruction-handling circuitry.

### BRIEF DESCRIPTION OF THE DRAWINGS

The accompanying drawings illustrate various embodiments of systems, methods, and embodiments of various other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 provides an exemplary coprocessing system within a core of a plurality of cores of a parallelized processing system with numerous similar cores in accordance with related art.

FIG. 2 provides an exemplary coprocessing system with synchronization circuitry and stall circuitry in accordance with specific embodiments of the inventions disclosed herein.

FIG. 3 provides an exemplary processor RISC0 and coprocessor in accordance with specific embodiments of the inventions disclosed herein.

FIG. 4 provides exemplary steps of controlling an order of execution of instructions at a coprocessor in accordance with specific embodiments of the inventions disclosed herein.

FIG. 5 provides examples of scenarios in which an instruction may or may not be delayed in accordance with specific embodiments of the inventions disclosed herein.

FIG. 6 provides an example of a system for synchronizing instructions between a processor and a coprocessor in accordance with specific embodiments of the inventions disclosed herein.

FIG. 7 provides an example of a system with synchronization circuitry selectively delaying instructions in an example set of instructions in accordance with specific embodiments of the inventions disclosed herein.

FIG. 8 provides an example of a method for synchronizing instructions between a processor and a coprocessor in accordance with specific embodiments of the inventions disclosed herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Different systems and methods for hardware managed synchronization of coprocessor instruction execution in accordance with the summary above are described in detail in this disclosure. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

Systems and methods related to coprocessor architectures are disclosed herein. In specific embodiments, a coprocessor architecture includes a synchronization block that handles the synchronization of computational instructions and memory access instructions in hardware so that programmers do not need to account for this synchronization when encoding workloads for the coprocessor architecture to execute. In specific embodiments, a processor and coprocessor may include two separate paths between the two processors, at least one for memory access instructions and one for computational instructions, which have different and variable delays. Accordingly, the synchronization block can sense these delays or sense when specific instructions have moved through the variable delay elements and can then delay one path or the other to enforce synchronization.

The communication path between a processor and coprocessor includes instruction-handling circuitry such as first-in first-out (“FIFO”) buffers, architecture-specific instruction preprocessing, and the like, for example, to perform staging and arbitration operations for instructions. This circuitry could perform operations such as preparing, ordering, buffering, checking, characterizing, and/or releasing instructions to the coprocessor. In some implementations, there may be separate communication paths for computational instructions and memory access instructions, and each may have their own instruction-handling circuitry. However the instruction-handling circuitry is configured within the system, this circuitry adds delays during the transmission of instructions from the processor to the coprocessor. The synchronization block monitors information about the instructions (e.g., the progress, status, and type of instruction) in flight through the instruction-handling circuitry, for example, by snooping data directly from the instruction-handling circuitry, before the instruction-handling circuitry, and/or after the instruction-handling circuitry, to understand the instructions that are progressing through the instruction-handling circuitry and to be prepared to initiate a stall of one of the instructions when necessary to maintain integrity and ordering between memory access instructions and computational instructions.

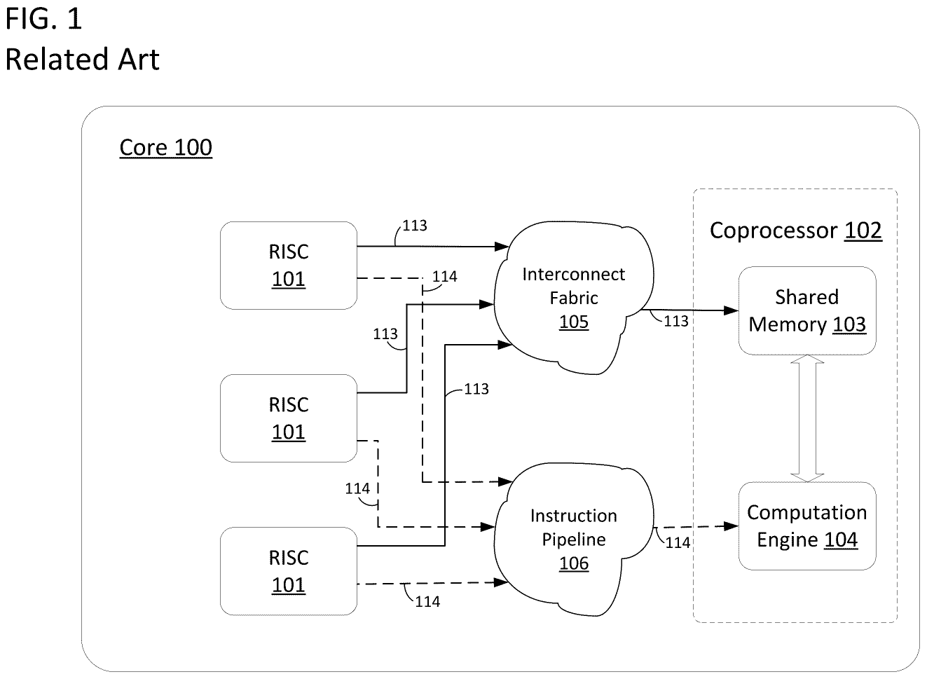

FIG. 1 depicts an exemplary coprocessing system, for example, within core 100 of a plurality of cores of a parallelized processing system with numerous similar cores in accordance with related art. The coprocessing system includes a set of processors 101 (e.g., reduced instruction set computer [“RISC”] processors) and a coprocessor 102. Where processors and coprocessors are described herein, a processor or a main processor may refer to any suitable processor that distributes instructions to a coprocessor. Each of a processor or coprocessor can be implemented in a variety of processing and circuitry types and combinations, and it will be understood that a reference herein to a particular type or combination of processing and circuitry for the processor or coprocessor is not intended to be limiting as to either a processor or coprocessor. Further, it will be understood that the depiction of FIG. 1 is provided in a simplified format and that various components, connections, circuits, etc. are omitted for ease of illustration. Additionally, although components are depicted with different symbols and/or blocks in FIG. 1, it will be understood that certain components may be collocated, for example, with portions of the interconnect fabric or instruction pipeline being physically located within a processor and/or coprocessor.

In the example depicted in FIG. 1, three processors 101 (e.g., three RISC processors) can send instructions (e.g., memory access instructions 113 or computational instructions 114) to a common coprocessor 102. Each of the RISC processors 101 outputs two types of instructions for processing by the coprocessor, although in different embodiments more instruction types may be output by any one RISC processor 101 and/or a RISC processor 101 may only output one type of instruction. In the example depicted in FIG. 1, each of the RISC processors 101 outputs both memory access instructions 113 (depicted with solid lines) and computational instructions 114 (depicted with dashed lines). Memory access instructions 113 are directed to shared memory 103 of coprocessor 102 and perform operations such as reading or writing to locations within shared memory 103, for example, to configuration registers that modify the mode of operation of coprocessor 102. Computational instructions 114 are directed to computation engine 104 of coprocessor 102 and cause computation engine 104 to perform computational operations. In some instances, the computation performed by computation engine 104 depends upon a configuration state of computation engine 104 defined by shared memory 103 or upon data that is stored in shared memory 103. In other instances, shared memory 103 and configuration state may be impacted by computations executed by computation engine 104 (e.g., writes to a location within shared memory 103 during a computation), and further memory access instructions 113 may depend on the output of the computation. Thus, the relative ordering of memory access instructions 113 and computational instructions 114 has a direct impact on functional correctness.

Each of the instructions is transmitted from a processor 101 (e.g., any one of the three RISC processors) to coprocessor 102 via instruction-handling circuitry. Although in specific embodiments the instruction-handling circuitry can be common shared circuitry for multiple types of instructions such as the memory access instructions and computational instructions, in FIG. 1 the memory access instructions 113 are handled by interconnect fabric 105 (e.g., a first instruction-handling circuitry) and the computational instructions 114 are handled by instruction pipeline 106 (e.g., a second instruction-handling circuitry). Although separate instruction-handling circuitry can be used for transmission paths between different processors to a coprocessor (e.g., between each RISC processor 101 and coprocessor 102), in the embodiment depicted in FIG. 1, a shared interconnect fabric 105 is utilized for all memory access instructions 113 from any of the three processors 101 to the shared memory 103 and a shared instruction pipeline 106 is utilized for all computational instructions 114 from any of the three processors 101 to the computation engine 104.

Interconnection fabric 105 provides preparation, staging, and arbitration of memory access instructions 113 from each of the three RISC processors 101 to shared memory 103 of coprocessor 102, while instruction pipeline 106 performs the preparation, staging, and arbitration of computational instructions 114 from each of the three RISC processors 101 to computation engine 104 of the coprocessor 102. In this manner, interconnect fabric 105 and instruction pipeline 106 sequence instructions between different RISC processors 101 as well as between memory access instructions 113 and computational instructions 114. However, the operations performed by these instruction-handling circuitries result in latencies which are variable based on the instruction loading, instruction types, and instruction sequence.

Because of these variable latencies, instructions may be delivered out of order in the absence of mitigating actions. If instructions are delivered out of order, a computation performed by computation engine 104 in response to a computational instruction 114 may use incorrect data (e.g., based on a value in shared memory 103 being changed too early or too late), or similarly, a memory read request (e.g., memory access instruction 113) may read stale data or data that was prematurely updated within shared memory 103 by the computation engine 104. Implementing software logic to avoid such situations imposes substantial costs both in terms of substantial overhead in additional programming and in delays required by those routines. Utilizing software techniques such as polling loops is difficult to implement in view of the many possibilities of loading, instruction types, instruction sequencing, and the like, that may occur.

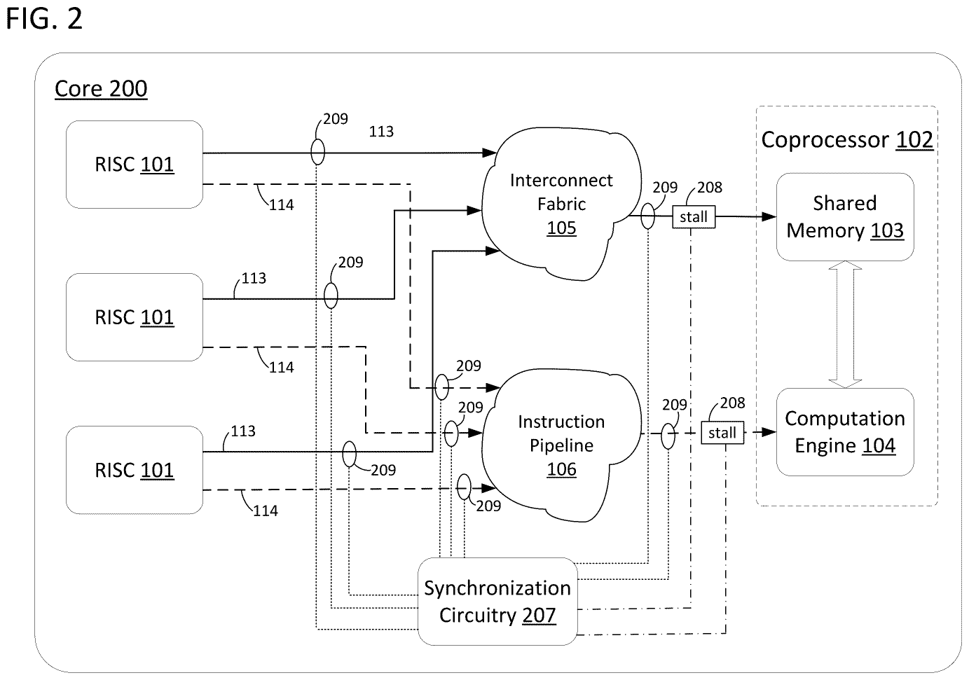

FIG. 2 depicts an exemplary coprocessing system with synchronization circuitry 207 and stall circuitry 208 in core 200 in accordance with an embodiment of the present disclosure. Core 200 may be one of a plurality of cores of a parallelized processing system with numerous similar cores. In the embodiment of FIG. 2, the same processors 101 (e.g., three RISC processors), instruction signal paths (e.g., solid lines for memory access instructions 113 and dashed lines for computational instructions 114), instruction-handling circuitry (e.g., interconnect fabric 105 for memory access instructions 113 and instruction pipeline 106 for computational instructions 114), and coprocessor 102 (e.g., including shared memory 103 such as configuration registers and computation engine 104) are depicted as in FIG. 1. In FIG. 2, on-chip circuitry is added to provide synchronization for instructions before delivery to coprocessor 102. In the embodiment of FIG. 2, this includes synchronization circuitry 207, stall circuitry 208 (e.g., stall circuitry 208 for each of the memory access instruction 113 and computational instruction 114 signal path to coprocessor 102), and monitoring or snooping connections 209 (e.g., at each instruction-handling circuitry input and each instruction-handling circuitry output).

In specific embodiments, synchronization circuitry 207 can be implemented with buffers, counters, comparators, and like circuitry to maintain information about the status of instructions within the instruction-handling circuitry, such as the type of instructions, dependencies of instructions of different types, relationships between instructions of the same type, number of instructions, and various counts and values determined therefrom. For example, in specific embodiments, synchronization circuitry 207 maintains information that quantifies the resources used based on the current buffer loading and “generation” numbers representative of an ordering of different instructions as “older” or “younger.” In this manner, local circuitry implemented in hardware logic is able to accurately and consistently determine whether an instruction needs to be stalled to prevent instructions being delivered to coprocessor 102 out of sequence.

In the example depicted in FIG. 2, synchronization circuitry 207 is depicted as snooping each of the signal paths into the instruction-handling circuitry and out of the instruction-handling circuitry via snooping connections 209. In this manner, synchronization circuitry 207 has current information as to every instruction within the instruction-handling circuitry and its status. Although synchronization circuitry 207 is depicted in FIG. 2 as monitoring these signal paths via snooping connections 209 providing simultaneous access to the data on each signal path, in specific embodiments some or all the monitoring of the instruction-handling circuitry could be based on directly monitoring the content of the instruction-handling circuitry (e.g., FIFO and other buffers). However the instruction-handling circuitry is monitored, as described herein the instruction-handling circuitry has variable delays. Synchronization circuitry 207, by monitoring the actual instructions being released from the instruction-handling circuitry and having knowledge of the sequencing of instructions and resource usage via monitoring of the inputs, is able to take immediate action as necessary to stall an instruction at stall circuitry 208 located between the instruction-handling circuitry and coprocessor 102. For example, synchronization circuitry 207 may stall a memory access instruction 113 (e.g., between interconnect fabric 105 and shared memory 103) and/or stall a computational instruction 114 (e.g., between instruction pipeline 106 and computation engine 104). Stall circuitry 208 can be any suitable circuitry (e.g., flip-flop, buffer, etc.) that is capable of holding an input prior to changing its output based on a control signal (e.g., from synchronization circuitry 207), and any suitable circuitry (e.g., logic gates) that is capable of making requests to coprocessor 102. High-speed logic can be utilized for monitoring the instruction as it is released from the instruction-handling circuitry to stall circuitry 208, such that the stall occurs on the same clock transition as the release of the instruction.

In specific embodiments, synchronization circuitry 207 may determine that one of the instructions to be output from one of the instruction-handling circuitries is “younger” than the other instruction, for example, based on the generation number associated with each instruction. Thus, the younger instruction can be stalled at stall circuitry 208 based on a control signal from synchronization circuitry 207. As an example, if a memory write instruction being released is younger than a computation instruction with a required configuration that is set by that memory write instruction or that needs to read the same memory location being written to, the memory instruction is stalled until the computation instruction can perform its read. As another example, if a younger computational instruction will change a value of a memory location that is the subject of a memory read instruction, the memory read instruction is delayed at stall circuitry 208 until the computational instruction is complete.

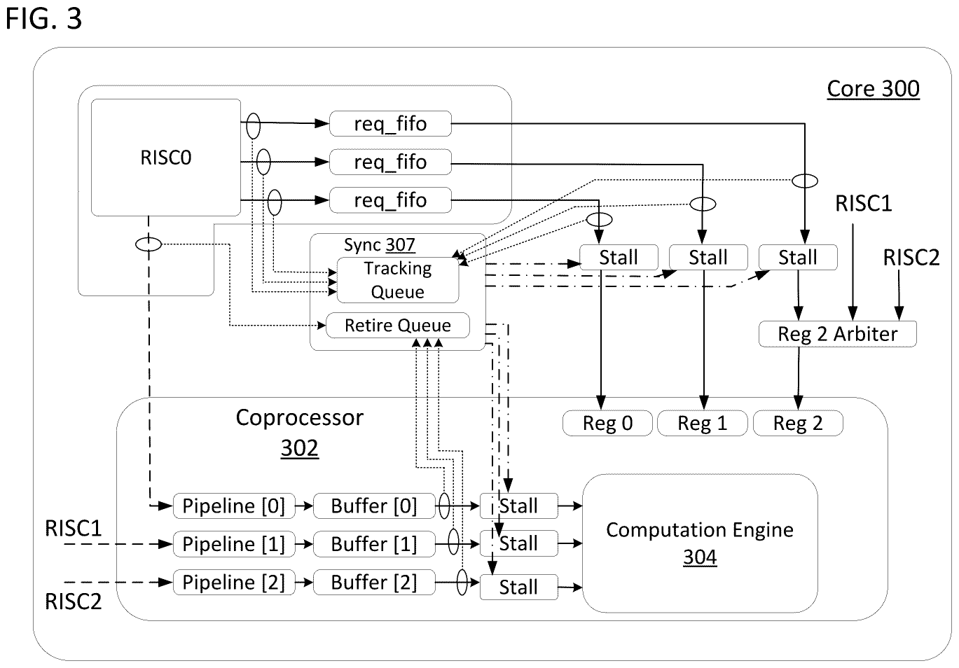

FIG. 3 depicts an exemplary processor RISC0 and coprocessor 302 in core 300 in specific embodiments of the present disclosure. Core 300 may be one of a plurality of cores of a parallelized processing system with numerous similar cores. Although particular components are depicted in a particular configuration in FIG. 3, it will be understood that the components are exemplary and are provided to illustrate the functionality of the present disclosure, and that additional components and implementations may be utilized in specific embodiments, and that components may be removed or modified.

In the example of FIG. 3, the processor is a RISC processor labeled as RISC0, while similar processors RISC1 and RISC2 are not depicted but have similar components and operations as the depicted RISC0, with memory access instructions being depicted for one register (e.g., solid lines labeled RISC1 and RISC2) and computational instruction being provided to coprocessor 302 (e.g., dashed lines labeled RISC1 and RISC2). The RISC processor RISC0 includes three FIFO buffers labeled as “req_fifo,” with each of the FIFO buffers queuing memory access instructions that are respectively directed to each of three separate configuration registers of the shared memory, labeled as Reg 0, Reg 1, and Reg 2. The registers can be any suitable register type, such as configuration registers or general-purpose registers. It will be understood that different buffer types, numbers of buffers, etc., may be utilized in different implementations, for example, to provide memory access instructions for different types and numbers of shared memory locations such as registers. Each RISC processor has an associated instruction pipeline that has delay stages for timing and instruction pre-processing capabilities. The “req_fifo” buffers are components of the interconnect fabric and may impart delays on memory access instructions as described herein.

As noted above, each of RISC1 and RISC2 are similar to RISC0, and include similar components that output both memory access instructions and computational instructions to coprocessor 302. Although these processors are not depicted in FIG. 3, the computational instructions from those processors (e.g., sent from a respective RISC processor via a respective instruction pipeline) are depicted as inputs to respective signal paths [1] and [2] within coprocessor 302, each signal path including a respective pipeline and buffer, and, in specific embodiments, respective stall circuitry. In addition, each of RISC1 and RISC2 may provide at least three memory access instruction outputs as depicted for RISC0, each of which may have their own signal and stall path (not depicted) prior to being provided to the registers. For one of the registers (Reg 2), an arbitration circuitry (Reg 2 Arbiter) for selecting which of the respective memory signals to send to a register (e.g., located after each respective stall path) is depicted, although it will be understood that a similar arbitration circuit and RISC1 and RISC2 memory instruction signal path may also be included in the path to Reg 0 and Reg 1, but are not depicted for ease of illustration.

Coprocessor 302 includes a signal path for each of the computational instruction inputs from the respective processors, with each of the signal paths passing through an instruction pipeline that imparts delays on the computational instructions before they arrive at computation engine 304. Coprocessor 302 also includes the registers Reg 0, Reg 1, and Reg 2 that can be written or read based on memory access instructions, and that may also be written or read as part of the execution of a computational instruction by computation engine 304. The registers can be architectural registers that set the state of computation engine 304 (e.g., depending upon the values in the registers, computation engine 304 may be in a different state such that a single computation instruction is executed using different operations based on the state). The registers can, in the alternative or in combination, be scratch pad registers that hold values which are used as operands or that are outputs produced by computation engine 304.

In the embodiment of FIG. 3, the synchronization circuitry includes two respective buffers that respectively include information about the status of instructions within the respective instruction-handling circuitry. For example, a tracking queue buffer tracks the interconnect fabric (e.g., the inputs and outputs of each req_fifo buffer for each of RISC0, RISC1, and RISC2) and statistics about memory access instructions within the interconnect fabric while the retire_queue tracks the associated RISC processor's instruction pipeline and statistics about computational instructions within the instruction pipeline. The inputs and outputs for the respective instruction-handling circuitries are snooped to populate the buffers and perform calculations, such as to determine resource usage and generation numbers. For example, for each RISC processor, snooping is performed before the req_fifo buffers to obtain incoming information about memory access instructions and after the req_fifo buffers to obtain outgoing information about memory instructions. Further, for each RISC processor, the output from the RISC processor to the start of the instruction pipeline is snooped to obtain incoming information about computational instructions. Outgoing information for the computational instructions is monitored by snooping within coprocessor 302, e.g., at the outputs for the respective buffers of the instruction pipeline.

Logic circuitry of synchronization circuitry 307 controls stall circuitry to stall instruction as described herein. In specific embodiments, subsets of shared memory locations and/or computational resources can be stalled independently. For example, each signal path for memory access instructions (e.g., in FIG. 3, three signal paths for each RISC processor) includes its own stall circuitry. This individualized control can be employed to optimize memory access instruction delivery. For example, if a computational instruction is reading or writing to a different register than a register subject to a memory access instruction, there is no risk of a case where the same register is read or written out of sequence. Each signal path for computational instructions also includes its own stall circuitry, depicted within coprocessor 302 between the buffers and computation engine 304 in the example of FIG. 3. Although the outgoing snooping connections are depicted at separate locations from the stall circuitry in FIG. 3 and FIG. 2, the outgoing snooping connections can be implemented within the stall circuitry, such that when a signal to be stalled arrives at the stall circuitry the stalling occurs on the same clock edge as signal arrival.

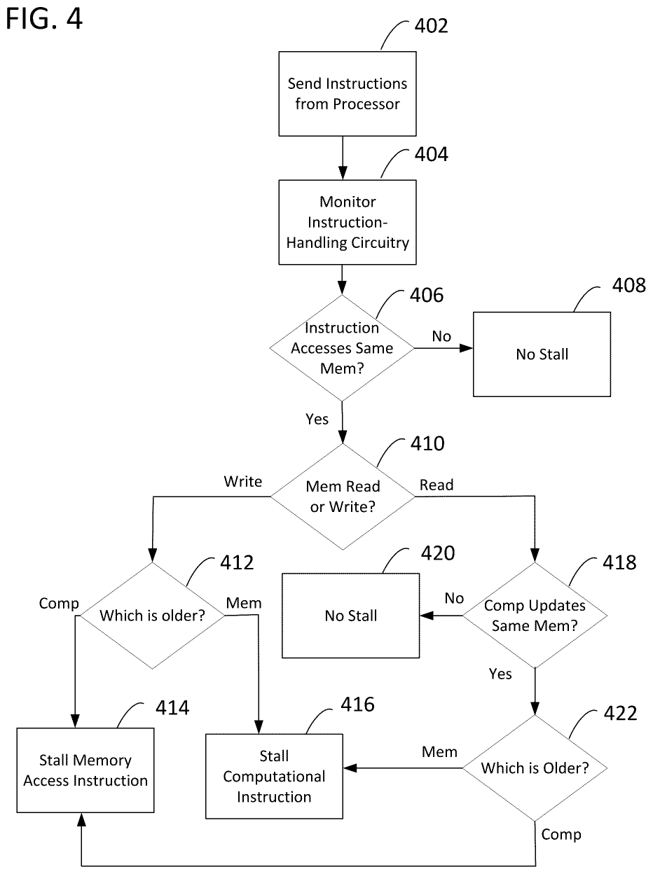

FIG. 4 depicts exemplary steps of controlling an order of execution of instructions at a coprocessor in accordance with specific embodiments of the present disclosure. Although particular steps are depicted in a particular order in FIG. 4, it will be understood that steps may be added, removed, or reordered in accordance with the present disclosure. FIG. 4 describes two instruction types (e.g., memory access instructions and computational instructions) sent from a single processor to a single coprocessor, but it will be understood that the steps of FIG. 4 can similarly be applied to multiple processors sending instructions to a shared coprocessor or multiple coprocessors, as well as additional instruction types.

Processing begins at step 402, where instructions are sent from a processor (e.g., a RISC processor) to be processed by a coprocessor (e.g., including a computation engine and shared memory). Instructions can include both memory access instructions that read or write to shared memory of the coprocessor and computational instructions that are executed by the computation engine, and which may read from or write to the shared memory during the execution of the computation. The instructions are sent to instruction-handling circuitry, for example, with the memory access instructions being sent to an interconnect fabric and the computational instructions being sent to an instruction pipeline. Processing then continues to step 404.

At step 404, synchronization circuitry monitors the instruction-handling circuitry, for example, with snooping connections at both the input and the output of each instruction-handling circuitry (e.g., at the inputs and outputs of both the interconnect fabric and the instruction pipeline). Based on this monitoring, information about the pending instructions is compiled (e.g., within a tracking queue and a retire queue) and relevant values calculated by logic circuitry of the synchronization circuitry to determine a status of outgoing instructions, for example, a relative generation of the memory access instruction and the computational instruction. Processing then continues to step 406.

At step 406, information about the instructions that are to be sent next from the instruction-handling circuitry to the coprocessor is analyzed (e.g., based on addresses, opcodes, etc.) to determine if the instructions are possibly directed to the same portion of shared memory, such as a common register. For example, if a computational instruction to be distributed may include reading or writing to a different memory location (e.g., a different register) of the shared memory than the location that is the subject of a memory access instruction, there is no possibility of improper ordering between a common memory resource and both instructions can be distributed (e.g., without stalling) at step 408. If the instruction may result in an improper ordering based on timing of instructions accessing or changing a shared memory resource, processing continues to step 410.

At step 410, the memory access instruction is assessed to determine whether it is a read or a write. In the alternative, or in addition to, assessing the memory instruction it is also possible to assess the computational instruction. Either way, the goal is to determine the cases where there is a potential for data to be updated too late or too early, for an instruction that is “younger” or “older.” In the example of FIG. 4 where the memory instruction is assessed, if the memory instruction is a write then processing continues to step 412 while if the memory instruction is a read then processing continues to step 418.

At step 412, it is determined which of the instructions (e.g., memory access instruction or computational instruction) is older, for example, based on generation values as determined by the synchronization circuitry. The determination of which instruction is older will determine the circumstances under which a stall is necessary and which instruction needs to be stalled. For example, if a computational instruction is older than a memory access instruction, the memory access instruction is stalled if the computational instruction requires updating the same shared memory location. Accordingly, if the computational instruction is older, processing continues to step 414 at which the memory access instruction is stalled. On the other hand, If the memory access instruction is older than the computational instruction, the computation instruction may be stalled whether the computation instruction requires reading or updating the shared memory. For example, if the computation instruction results in a write to the shared memory, then the memory instruction should execute first to allow the correct value to be available for the read. If the computational instruction requires updating the shared memory and the memory instruction is older than the computation instruction, the memory instruction should execute first so the value within the shared memory is the younger or newer value of the computational instruction. Accordingly, if the memory instruction is older, processing continues to step 416 at which the computation instruction is stalled.

Processing has reached step 418 if both the computational instruction and the memory access instruction are operating on the same location of shared memory (step 406), and where the memory instruction is a read instruction (step 410). At step 418, it is determined if the computational instruction will update the location within shared memory. If not, processing can continue to step 420 at which point no stall is initiated for either of the instructions, since neither instruction will be changing a shared value. If the computational instruction will update the shared memory location, processing continues to step 422.

At step 422 it is determined which instruction is older. If the memory access instruction is older, the memory instruction should be allowed to read the location of the shared memory prior to the updating by execution of the computational instruction, and processing continues to step 416 to stall the computational instruction. If the memory access instruction is younger, the computational instruction should be allowed to update the location of the shared memory prior to the read caused by the memory access instruction, and processing continues to step 414 to stall the computational instruction. In this way, the system may handle the synchronization of computational instructions and memory access instructions so that programmers do not need to account for this synchronization when encoding workloads for the coprocessor architecture to execute.

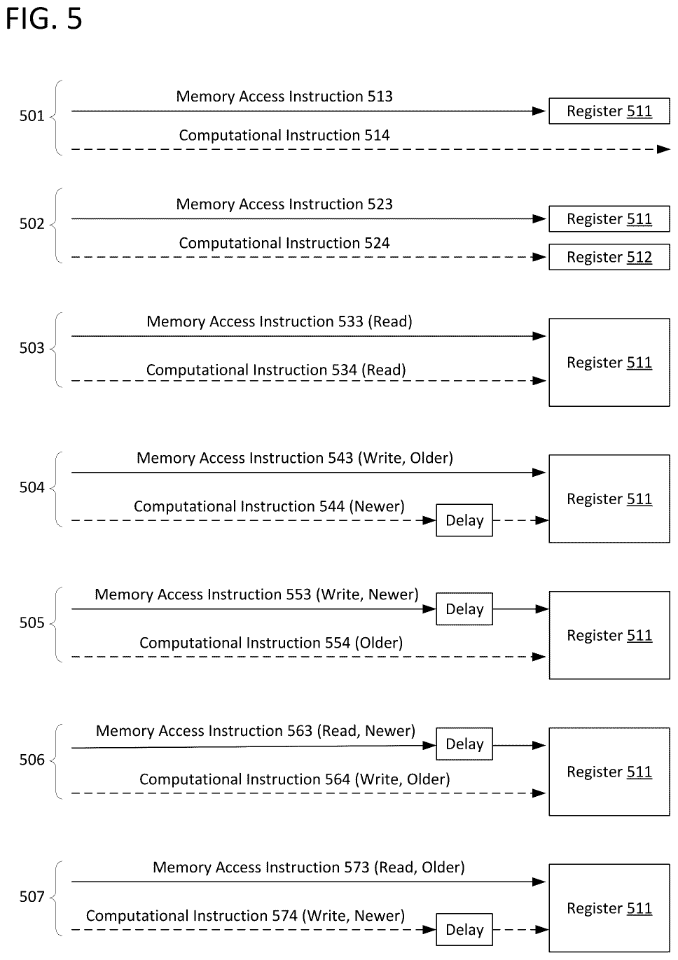

FIG. 5 provides examples of scenarios in which an instruction may or may not be delayed in accordance with specific embodiments of the present disclosure. A processor may, for example, output both memory access instructions (depicted with solid lines) and computational instructions (depicted with dashed lines), although other types of instructions and combinations of instructions are possible. Memory access instructions may be directed to a shared memory of a coprocessor and may perform operations such as reading from or writing to locations within the shared memory. For example, a memory access instruction may write to configuration registers that modify the mode of operation of the coprocessor. Computational instructions may be directed to a computation engine of the coprocessor and may cause the computation engine to perform computational operations. In some instances, the computation performed by the computation engine depends upon a configuration state of the computation engine defined by the shared memory or upon data that is stored in the shared memory. In other instances, the shared memory and configuration state may be impacted by computations executed by the computation engine (e.g., writes to a location within the shared memory during a computation), and further memory access instructions may depend on the output of the computation. Thus, the relative ordering of memory access instructions and computational instructions has a direct impact on functional correctness. Synchronization circuitry may be configured to determine whether to delay the memory access instruction, the computational instruction, or neither. To make this determination, the synchronization circuitry may determine whether a memory access instruction is directed to a first register or a second register of a coprocessor, determine whether a computational instruction requires access (to be executed) to the first register or the second register of the coprocessor, and determine the relative ages of the instruction (e.g., via generation numbers).

In scenario 501, memory access instruction 513 is directed to register 511 and computational instruction 514 does not require access to any register. In this case, neither memory access instruction 513 nor computational instruction 514 is delayed.

In scenario 502, memory access instruction 523 is directed to register 511 and computational instruction 524 requires access to register 512 (e.g., a register that is different from register 511). In this case, neither memory access instruction 523 nor computational instruction 524 is delayed.

In scenario 503, memory access instruction 533 and computational instruction 534 both may read from register 511 (e.g., neither write to or change data stored in register 511). In this case, neither memory access instruction 533 nor computational instruction 534 is delayed.

In scenario 504, memory access instruction 543 may write to register 511 and computational instruction 544 requires access to the same register 511. Computational instruction 544 may access register 511 in order to read from register 511. As memory access instruction 543 is older than computational instruction 544, computational instruction 544 is delayed. In specific embodiments, the synchronization circuitry may determine that computational instruction 544 is younger (newer) than memory access instruction 543 based on the generation number associated with each instruction.

In scenario 505, memory access instruction 553 may write to register 511 and computational instruction 554 may require access to the same register 511. Computational instruction 554 may access register 511 in order to read from register 511. As computational instruction 554 is older than memory access instruction 553, memory access instruction 553 is delayed. In specific embodiments, the synchronization circuitry may determine that memory access instruction 553 is younger (newer) than computational instruction 554 based on the generation number associated with each instruction.

In scenario 506, memory access instruction 563 may read from register 511 and computational instruction 564 may require access to the same register 511. Computational instruction 564 may require access to register 511 to write to register 511. As computational instruction 564 is older than memory access instruction 563, memory access instruction 563 is delayed. In specific embodiments, the synchronization circuitry may determine that memory access instruction 563 is younger (newer) than computational instruction 564 based on the generation number associated with each instruction.

In scenario 507, memory access instruction 573 may read from register 511 and computational instruction 574 may require access to the same register 511. Computational instruction 574 may access register 511 in order to write to register 511. As memory access instruction 573 is older than computational instruction 574, computational instruction 574 is delayed. In specific embodiments, the synchronization circuitry may determine that computational instruction 574 is younger (newer) than memory access instruction 573 based on the generation number associated with each instruction.

By determining whether a memory access instruction is directed to a first register or a second register of a coprocessor, determining whether a computational instruction requires access (to be executed) to the first register or the second register of the coprocessor, and determining the relative ages of the instructions (e.g., via generation numbers), synchronization circuitry may determine whether to delay the memory access instruction, the computational instruction, or neither. In this way, the system may handle the synchronization of computational instructions and memory access instructions so that programmers do not need to account for this synchronization when encoding workloads for the coprocessor architecture to execute.

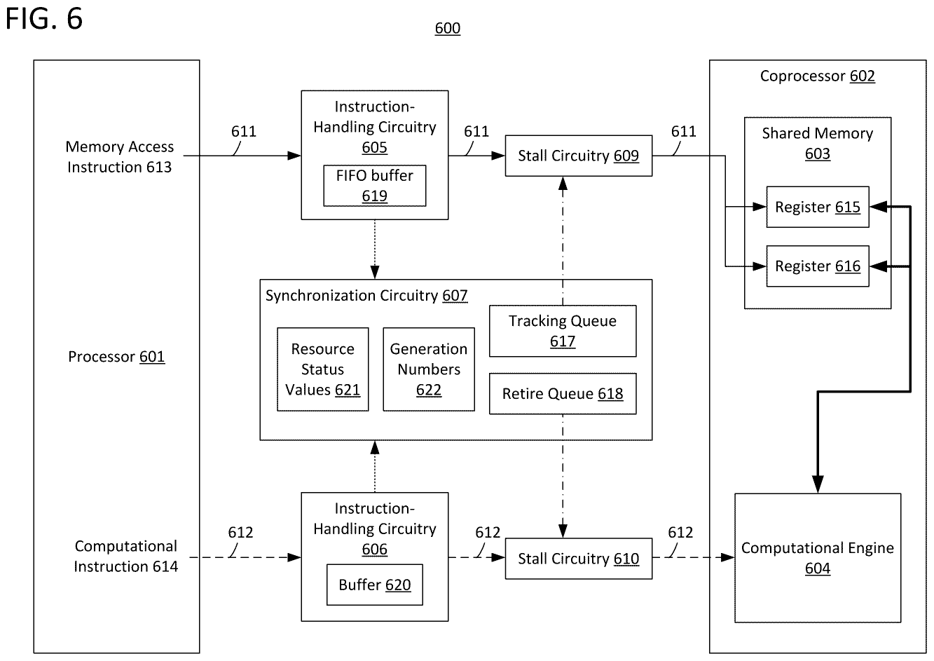

FIG. 6 provides an example of system 600 for synchronizing instructions between processor 601 and coprocessor 602 in accordance with specific embodiments of the present disclosure. Although particular components are depicted in a particular configuration in FIG. 6, it will be understood that the components are exemplary and are provided to illustrate the functionality of the present disclosure, and that additional components and implementations may be utilized in specific embodiments, and that components may be removed or modified. System 600 may include processor 601, coprocessor 602, instruction-handling circuitry 605, instruction-handling circuitry 606, stall circuitry 609, stall circuitry 610, and synchronization circuitry 607. Instruction-handling circuitry 605 and stall circuitry 609 may be located along transmission path 611 (solid line) for instructions of a first type. Instruction-handling circuitry 606 and stall circuitry 610 may be located along transmission path 612 (dashed line) for instructions of a second type. In specific embodiments, the first instruction type may be a memory access instruction type and the second instruction type may be a computational instruction type, such that memory access instruction 613 traverses transmission path 611 and computational instruction 614 traverses transmission path 612. Both transmission paths 611 and 612 may transmit messages from processor 601 to coprocessor 602, however each transmission path 611 and 612 may have different and variable delays.

Processor 601 may be configured to generate first instructions of a first instruction type (e.g., memory access instructions) and second instructions of a second instruction type (e.g., computational instructions). Coprocessor 302 may be configured to perform a first operation type for the first instructions and a second operation type for the second instructions. For example, coprocessor 302 may be configured to perform load (read) or store (write) operations for memory access instructions and to perform arithmetic, logical, and shift operations for computational instructions. Computational instruction 614 may be directed to computation engine 604 of coprocessor 602. Memory access instruction 613 may be directed to shared memory 603 of coprocessor 602.

Instruction-handling circuitry 605 and 606 may perform operations such as preparing, ordering, buffering, checking, characterizing, and/or releasing instructions to coprocessor 602. Instruction-handling circuitry 605 may be within transmission path 611, between processor 601 and coprocessor 602. Memory access instruction 613 may be transmitted from processor 601 to coprocessor 602 via instruction-handling circuitry 605. Instruction-handling circuitry 606 may be within transmission path 612, between processor 601 and coprocessor 602.

Computational instruction 614 may be transmitted from processor 601 to coprocessor 602 via instruction-handling circuitry 606. Instruction-handling circuitry 605 may include FIFO buffer 619. In specific embodiments, instruction-handling circuitry 605 may include more than one buffer. Instruction-handling circuitry 606 may include buffer 620. In specific embodiments, instruction-handling circuitry 606 may include more than one buffer. Instruction-handling circuitry 605 and 606 may include architecture-specific instruction preprocessing and may perform staging and arbitration operations for instructions (e.g., memory access instruction 613 and computational instruction 614. In specific embodiments, instruction-handling circuitry 605 comprises an interconnect fabric and instruction-handling circuitry 606 comprises an instruction pipeline. Instruction-handling circuitry 605 and 606 may have different and variable delays.

Synchronization circuitry 607 may monitor information about the instructions 613 and 614 (e.g., the progress, status, and type of instruction) in flight through the instruction-handling circuitry 605 and 606. Synchronization circuitry 607 may be coupled to instruction-handling circuitry 605 and instruction-handling circuitry 606. In specific embodiments, synchronization circuitry 607 may be coupled to an input of instruction-handling circuitry 605, an output of instruction-handling circuitry 605, an input of instruction-handling circuitry 606, and an output of instruction-handling circuitry 606. Synchronization circuitry 607 may monitor instruction-handling circuitry 605 and instruction-handling circuitry 606. Synchronization circuitry 607 may control stall circuitry 609 and stall circuitry 610. Stall circuitry 609 may be located between instruction-handling circuitry 605 and coprocessor 602. Stall circuitry 610 may be located between instruction-handling circuitry 606 and coprocessor 602. Synchronization circuitry 607 may be configured to selectively delay delivery (e.g., to coprocessor 602) of memory access instruction 613 at stall circuitry 609 or computational instruction 614 at stall circuitry 610 based on monitoring instruction-handling circuitry 605 and instruction-handling circuitry 606.

In specific embodiments, computational instruction 614 may be directed to computation engine 604 of coprocessor 602. Memory access instruction 613 may be directed to shared memory 603 of coprocessor 602. Memory access instruction 613 may either read from or write to shared memory 603. Shared memory 603 may comprise register 613 and register 616. In specific embodiments, shared memory 603 may have only one register or may have more than two registers. Register 615 and register 616 may modify a functioning of coprocessor 602. For example, the execution of a computational instruction may be impacted by the state of shared memory 603. In specific embodiments, register 615 may be a configuration register and register 616 may be a shared memory register.

Synchronization circuitry 607 may be configured to determine various aspects of memory access instruction 613 and computational instruction 614. Synchronization circuitry 607 may be configured to determine whether memory access instruction 613 is directed to register 615 or register 616. Synchronization circuitry 607 may be configured to determine whether computational instruction 614 requires access to register 615 or register 616 to be executed. Synchronization circuitry 607 may be configured to determine whether computational instruction 614 requires access to the same register to which memory access instruction 613 is directed. Synchronization circuitry 607 may also be configured to determine whether to selectively delay memory access instruction 613 or computational instruction 614 based on whether memory access instruction 613 is directed to the same register to which computational instruction 614 requires access and, in specific embodiments, based on whether memory access instruction 613 or computational instruction 614 is older.

In specific embodiments, synchronization circuitry 607 may include buffers, counters, comparators, and like circuitry to maintain information about the status of instructions (e.g., resource status values 621, generation numbers 622) within instruction-handling circuitry 605 and 606. For example, synchronization circuitry 607 may maintain information such as the type of instructions, dependencies of instructions of different types, relationships between instructions of the same type, number of instructions, and various counts and values determined therefrom. In specific embodiments, synchronization circuitry 607 may be configured to determine one or more resource status values 621 and one or more generation numbers 622 based on monitoring instruction-handling circuitry 605 and instruction-handling circuitry 606. For example, in specific embodiments, synchronization circuitry 607 maintains information that quantifies the resources used (e.g., via a resource status value 621) based on the current buffer loading and generation numbers 622 representative of an ordering of different instructions as “older” or “younger.” In this manner, synchronization circuitry 607 may be able to accurately and consistently determine whether an instruction (such as memory access instruction 613 or computational instruction 614) needs to be stalled (by stall circuitry 609 or stall circuitry 610, respectively) to prevent instructions being delivered to coprocessor 602 out of sequence. Selectively delaying delivery of memory access instruction 613 or computational instruction 614 may be based on a resource status value 621 and/or a generation number 622.

Stall circuitry 609 may be configured to delay memory access instruction 613 directed to register 615 or register 616. Stall circuitry 610 may be configured to delay computational instruction 614 requiring access to register 615 or register 616. In specific embodiments, synchronization circuitry 607 may comprise tracking queue 617 to perform the control of stall circuitry 609 and retire queue 618 to perform the control of stall circuitry 610.

In the embodiment of FIG. 6, the synchronization circuitry may include two buffers that respectively include information about the status of instructions within the two instruction-handling circuitries 605 and 606. For example, tracking queue 617 may track instruction-handling circuitry 605 (e.g., the inputs and outputs of instruction-handling circuitry 605) and statistics about memory access instruction 613 within instruction-handling circuitry 605 while retire queue 618 may track instruction-handling circuitry 606 and statistics about computational instruction 614 within instruction-handling circuitry 606. The inputs and outputs for the respective instruction-handling circuitries 605 and 606 may be snooped to populate tracking queue 617 and retire queue 618 and perform calculations, such as to determine resource status values 621 and generation numbers 622. For example, snooping may be performed before FIFO buffer 619 to obtain incoming information about memory access instruction 613 and after FIFO buffer 619 to obtain outgoing information about memory access instruction 613. Snooping may be performed before buffer 620 to obtain incoming information about computational instruction 614 and after buffer 620 to obtain outgoing information about computational instruction 614. For example, outgoing information for computational instruction 614 may be monitored by snooping within coprocessor 602.

By determining the relative ages of the instructions (e.g., via generation numbers, resource status values 621), synchronization circuitry 607 may determine whether to delay memory access instruction 613, computational instruction 614, or neither. In this way, system 600 may handle the synchronization of computational instructions and memory access instructions so that programmers do not need to account for this synchronization when encoding workloads for the coprocessor architecture to execute.

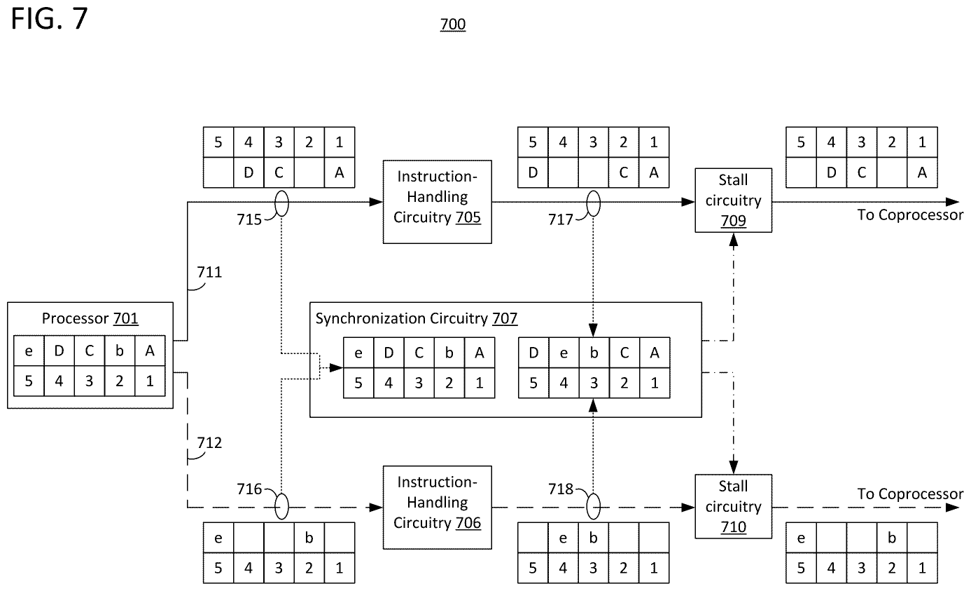

FIG. 7 provides an example of system 700 showing synchronization circuitry 707 selectively delaying instructions in an example set of instructions in accordance with specific embodiments of the present disclosure. Although particular components are depicted in a particular configuration in FIG. 7, it will be understood that the components are exemplary and are provided to illustrate the functionality of the present disclosure, and that additional components and implementations may be utilized in specific embodiments, and that components may be removed or modified. In the example of FIG. 7, instructions are ordered (from oldest to youngest): A, b, C, D, and e, where uppercase A, C, and D refer to one instruction type (e.g., memory access instructions) while lowercase b and e refer to another instruction type (e.g., computational instructions). Although five instructions of two types are shown, any number of instructions and any number of instruction types may be present. Processor 701 may generate instructions A, b, C, D, and e, which may be directed to a coprocessor (not shown). Instructions A, C, and D may traverse transmission path 711 to arrive at a coprocessor. Transmission path 711 may include instruction-handling circuitry 705 and stall circuitry 709. Instructions b and e may traverse transmission path 712 to arrive at the coprocessor. Transmission path 712 may include instruction-handling circuitry 706 and stall circuitry 710.

Synchronization circuitry 707 may include or be coupled to snooping connection 715 at an input to instruction-handling circuitry 705, snooping connection 717 at an output of instruction-handling circuitry 705, snooping connection 716 at an input to instruction-handling circuitry 706, and snooping connection 718 at an output of instruction-handling circuitry 706. Synchronization circuitry 707 may monitor instruction-handling circuitry 705 using snooping connection 715 and snooping connection 717. Synchronization circuitry 707 may monitor instruction-handling circuitry 706 using snooping connection 716 and snooping connection 718.

At snooping connection 715, synchronization circuitry 707 may determine that instruction A belongs in timeslot 1, instruction C belongs in timeslot 3, and instruction D belongs in timeslot 4. Similarly, at snooping connection 716, synchronization circuitry 707 may determine that instruction b belongs in timeslot 2 and instruction e belongs in timeslot 5. The example of timeslots are for explanatory purposes only, as synchronization circuitry 707 may use a variety of resource values, generation numbers, or other means for determining the proper or intended order of the instructions. The “timeslots” may be abstract and refer to the relative ordering of the instructions.

Instruction-handling circuitry 705 and 706 may have different and variable delays, changing the relative timing of the different instructions. In the example of FIG. 7, instructions C is processed in instruction-handling circuitry 705 faster than instruction b is processed in instruction-handling circuitry 706; instructions D is processed in instruction-handling circuitry 705 slower than instruction e is processed in instruction-handling circuitry 706. That is, instruction b moves from timeslot 2 to timeslot 3, instruction C moves from timeslot 3 to timeslot 2, instruction D moves from timeslot 4 to timeslot 5, and instruction e moves from timeslot 5 to timeslot 4. Synchronization circuitry 707 may detect this out-of-order sequence instructions via snooping connections 717 and 718. In specific situations, the instruction reordering may cause errors. For example, one instruction may rewrite a value before another instruction has a chance to read the value. As another example, one instruction may read a value before another instruction has a chance to properly update the value to the intended read value. Accordingly, the relative ordering of instructions (e.g., memory access instructions and computational instructions) may have a direct impact on functional correctness.

Synchronization circuitry 707 may be configured to determine whether to delay instructions relative to other instructions to fix the ordering of the instructions. For example, synchronization circuitry 707 may compare the current timeslots (via snooping connections 717 and 718 respectively) and intended timeslots (via snooping connections 715 and 716 respectively) for instruction C from transmission path 711 and instruction b from transmission path 712. Synchronization circuitry 707 may determine that instruction b, although behind instruction C, should be ahead of instruction C. Synchronization circuitry 707 may accordingly cause stall circuitry 709 to delay instruction C such that instruction b reaches the coprocessor before instruction C reaches the coprocessor.

In the example of FIG. 7, synchronization circuitry 707 may also compare the current timeslots (via snooping connections 717 and 718 respectively) and intended timeslots (via snooping connections 715 and 716 respectively) for instruction D from transmission path 711 and instruction e from transmission path 712. Synchronization circuitry 707 may determine that instruction D, although behind instruction e, should be ahead of instruction e. Synchronization circuitry 707 may accordingly cause stall circuitry 710 to delay instruction e such that instruction D reaches the coprocessor before instruction e reaches the coprocessor.

In some situations, an instruction may be compared to multiple other instructions. In some situations, an instruction may be delayed multiple times. For example, processor 701 may generate and transmit instructions f, g, and H (in that order) with instructions f and g being a first type of instruction traversing transmission path 712 and instruction H being a second type of instruction traversing transmission path 711. In this example, instruction-handling circuitry 705 may process instructions H before instruction-handling circuitry 706 processes instruction for instruction g, such that the instructions are reordered H, f, g. Synchronization circuitry 707 may compare intended and current timeslots for instruction H and instruction f and determine that instruction H should be delayed. Synchronization circuitry 707 may also compare intended and current timeslots for instruction H and instruction g and determine that instruction H should be delayed again. In this case, stall circuitry 709 effectively delays instruction H twice. In specific embodiments, this “double delay” may be implemented as a single delay.

In some situations, a reordering of the instructions may be acceptable. For example, if different instructions access different registers, neither instructions cause changes to the shared memory of the coprocessor, etc. then synchronization circuitry 707 may refrain from delaying the instructions (e.g., refrain from rearranging) the instruction order.

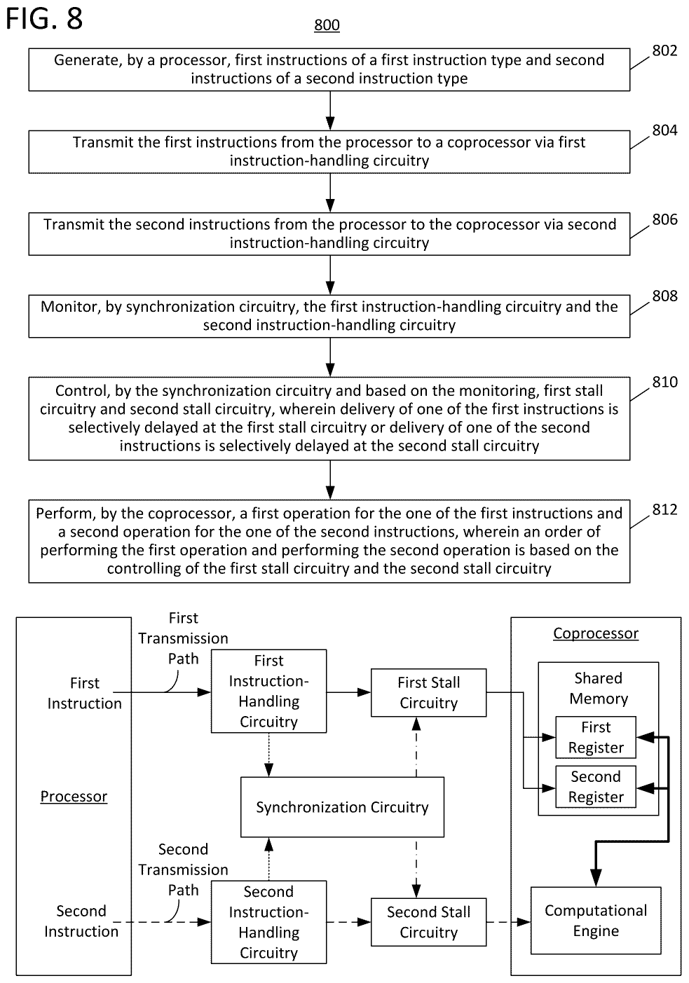

FIG. 8 provides an example of method 800 for synchronizing instructions between a processor and a coprocessor in accordance with specific embodiments of the present disclosure. A system implementing method 800 may include a processor, a coprocessor, a first instruction-handling circuitry, a second instruction-handling circuitry, first stall circuitry, second stall circuitry, and synchronization circuitry. In specific embodiments, the system may also include a first input snooping connection at an input to the first instruction-handling circuitry, a first output snooping connection at an output of the first instruction-handling circuitry, a second input snooping connection at an input to the second instruction-handling circuitry, and a second output snooping connection at an output of the second instruction-handling circuitry. In specific embodiments, the synchronization circuitry of the system may include a tracking queue and a retire queue. In specific embodiments, the first instruction-handling circuitry of the system may include at least one FIFO buffer, and/or an interconnect fabric; and the second instruction-handling circuitry may include at least one buffer and/or an instruction pipeline. Steps, or portions of steps, of method 800 may be omitted, duplicated, rearranged, or otherwise deviate from the form shown. Additional steps may be inserted into method 800.

At step 802, a processor may generate first instructions of a first instruction type and second instructions of a second instruction type. In specific embodiments, the first instruction type may be a memory access instruction type and the second instruction type may be a computational instruction type. In specific embodiments, the first instructions may be directed to a shared memory of the coprocessor and the first instructions may either read or write to the shared memory. The shared memory may comprise one or more registers, and the one or more registers may modify a functioning of the coprocessor. In specific embodiments, the one or more registers may comprise a first register that is a configuration register and a second register that is a shared memory register. In specific embodiments, the second instructions may be directed to a computation engine of the coprocessor.

At step 804, the first instructions may be transmitted from the processor to a coprocessor via a first instruction-handling circuitry. In specific embodiments, the first instruction-handling circuitry may comprise at least one FIFO buffer. In specific embodiments, the first instruction-handling circuitry may comprise an interconnect fabric. In specific embodiments, the first instruction-handling circuitry may be part of (e.g., within) a first transmission path between the processor and the coprocessor.

At step 806, the second instructions may be transmitted from the processor to the coprocessor via a second instruction-handling circuitry. In specific embodiments, the second instruction-handling circuitry may include at least one buffer. In specific embodiments, the second instruction-handling circuitry comprises an instruction pipeline. In specific embodiments, the second instruction-handling circuitry may be part of (e.g., within) a second transmission path between the processor and the coprocessor. The first transmission path may be different than the second transmission path, such that the first transmission path includes the first instruction-handling circuitry while the second transmission path does not and the second transmission path includes the second instruction-handling circuitry while the first transmission path does not. At step 808, synchronization circuitry may monitor the first instruction-handling circuitry and the second instruction-handling circuitry. In specific embodiments, the synchronization may be coupled to a first input snooping connection at an input to the first instruction-handling circuitry, a first output snooping connection at an output of the first instruction-handling circuitry, a second input snooping connection at an input to the second instruction-handling circuitry, and a second output snooping connection at an output of the second instruction-handling circuitry. The synchronization circuitry may monitor the first instruction-handling circuitry based on the first input snooping connection and the first output snooping connection. The synchronization circuitry may monitor the second instruction-handling circuitry based on the second input snooping connection and the second output snooping connection. In specific embodiments, the synchronization circuitry may be configured to determine a resource status value and a generation number based on the monitoring of the first instruction-handling circuitry and the second instruction-handling circuitry.

At step 810, the synchronization circuitry may control first stall circuitry and second stall circuitry based on the monitoring (e.g., at step 808). The first stall circuitry may be located between the first instruction-handling circuitry and the coprocessor. The second stall circuitry may be located between the second instruction-handling circuitry and the coprocessor. Delivery of one of the first instructions may be selectively delayed at the first stall circuitry or delivery of one of the second instructions may be selectively delayed at the second stall circuitry. In specific embodiments, the first stall circuitry may be configured to individually delay first instructions directed to the first register or the second register. For example, in specific embodiments, a first instruction may be selectively delayed if it is directed to a shared memory register (e.g., a register also accessible to the computation engine or other instructions that are not the first type of instruction) while a first instruction that is directed to a non-shared memory may not be selectively delayed. In specific embodiments, the synchronization circuitry includes a tracking queue to perform the control of the first stall circuitry and a retire queue to perform the control of the second stall circuitry. In specific embodiments, selectively delaying delivery of one of the first instructions or one of the second instructions is based on the resource status value and the generation number.

In specific embodiments, the synchronization circuitry may determine whether a memory access instruction of the first instructions is directed to the first register or the second register, determine whether a computational instruction to be executed requires access to the first register or the second register, and determine whether to selectively delay one of the memory access instruction or the computational instruction based on whether the memory access instruction is directed to a same register to which the computational instruction requires access. When the memory access instruction is directed to a different register than that which the computational instruction requires access, neither the memory access instruction nor the computational instruction may be delayed. When the computational instruction does not require access to any of the one or more registers, neither the memory access instruction nor the computational instruction may be delayed. When the memory access instruction is directed to the same register as that which the computational instruction requires access, the memory access instruction is a write instruction, and the computational instruction requires a read to the same register, the computational instruction may be delayed if it is newer than the memory access instruction. When the memory access instruction is directed to the same register as that which the computational instruction requires access, the memory access instruction is a read instruction, and the computational instruction causes a write to the same register, the memory access instruction may be delayed if it is newer than the computational instruction.

At step 812, the coprocessor may perform a first operation for the one of the first instructions and a second operation for the one of the second instructions. The order of performing the first operation and performing the second operation may be based on the controlling (e.g., at step 810) of the first stall circuitry and the second stall circuitry.

By determining whether a first instruction is directed to a first register or a second register of a coprocessor, determining whether a second instruction requires access to the first register or the second register of the coprocessor, and determining the relative ages of the instructions (e.g., via generation numbers), synchronization circuitry may determine whether to delay the first instruction, the second instruction, or neither. In this way, the system may handle the synchronization of multiple types of instructions with variable and different delays so that programmers do not need to account for this synchronization when encoding workloads for the coprocessor architecture to execute.

While the specification has been described in detail with respect to specific embodiments of the invention, it will be appreciated that those skilled in the art, upon attaining an understanding of the foregoing, may readily conceive of alterations to, variations of, and equivalents to these embodiments. Although examples in the disclosure were generally directed to a processor sending instructions to a coprocessor, the same approaches could be utilized to order instructions in a variety of situations where instructions travel on different paths or with different delays. These and other modifications and variations to the present invention may be practiced by those skilled in the art, without departing from the scope of the present invention, which is more particularly set forth in the appended claims.

What is claimed is:

1. A system for synchronizing instructions between a processor and a coprocessor, comprising:
a processor configured to generate first instructions of a first instruction type and second instructions of a second instruction type;
a coprocessor configured to perform a first operation type for the first instructions and a second operation type for the second instructions;
a first instruction-handling circuitry within a first transmission path between the processor and the coprocessor, wherein the first instructions are transmitted from the processor to the coprocessor via the first instruction-handling circuitry;
a second instruction-handling circuitry within a second transmission path between the processor and the coprocessor, wherein the second instructions are transmitted from the processor to the coprocessor via the second instruction-handling circuitry;
first stall circuitry located between the first instruction-handling circuitry and the coprocessor;
second stall circuitry located between the second instruction-handling circuitry and the coprocessor; and
synchronization circuitry coupled to monitor the first instruction-handling circuitry and the second instruction-handling circuitry and to control the first stall circuitry and the second stall circuitry, wherein the synchronization circuitry is configured to selectively delay delivery of one of the first instructions at the first stall circuitry or one of the second instructions at the second stall circuitry based on the monitoring of the first instruction-handling circuitry and the second instruction-handling circuitry.

2. The system of claim 1, wherein:
the first instruction type is a memory access instruction type; and
the second instruction type is a computational instruction type.

3. The system of claim 2, wherein:
the first instructions are directed to a shared memory of the coprocessor;
the second instructions are directed to a computation engine of the coprocessor; and
the first instructions either read or write to the shared memory.

4. The system of claim 3, wherein:
the shared memory comprises one or more registers; and
the one or more registers modify a functioning of the coprocessor.

5. The system of claim 4, wherein the one or more registers comprise:
a first register that is a configuration register; and
a second register that is a shared memory register.

6. The system of claim 5, wherein the first stall circuitry is configured to individually delay first instructions directed to the first register or the second register.

7. The system of claim 5, wherein the synchronization circuitry is configured to (i) determine whether a memory access instruction of the first instructions is directed to the first register or the second register, (ii) determine whether a computational instruction to be executed requires access to the first register or the second register; and (iii) determine whether to selectively delay one of the memory access instruction or the computational instruction based on whether the memory access instruction is directed to a same register to which the computational instruction requires access.

8. The system of claim 7, wherein, when the memory access instruction is directed to a different register than that which the computational instruction requires access, neither the memory access instruction nor the computational instruction is delayed.

9. The system of claim 7, wherein, when the computational instruction does not require access to any of the one or more registers, neither the memory access instruction nor the computational instruction is delayed.

10. The system of claim 7, wherein, when the memory access instruction is directed to the same register as that which the computational instruction requires access, the memory access instruction is a write instruction, and the computational instruction requires a read to the same register, the computational instruction is delayed if it is newer than the memory access instruction.

11. The system of claim 7, wherein, when the memory access instruction is directed to the same register as that which the computational instruction requires access, the memory access instruction is a read instruction, and the computational instruction causes a write to the same register, the memory access instruction is delayed if it is newer than the computational instruction.

12. The system of claim 1, further comprising:
a first input snooping connection at an input to the first instruction-handling circuitry;
a first output snooping connection at an output of the first instruction-handling circuitry;
a second input snooping connection at an input to the second instruction-handling circuitry; and
a second output snooping connection at an output of the second instruction-handling circuitry, wherein the synchronization circuitry monitors the first instruction-handling circuitry based on the first input snooping connection and the first output snooping connection, and wherein the synchronization circuitry monitors the second instruction-handling circuitry based on the second input snooping connection and the second output snooping connection.

13. The system of claim 12, wherein the synchronization circuitry comprises:
a tracking queue to perform the control of the first stall circuitry; and
a retire queue to perform the control of the second stall circuitry.

14. The system of claim 13, wherein the first instruction-handling circuitry comprises at least one first-in first-out (“FIFO”) buffer and the second instruction-handling circuitry includes at least one buffer.

15. The system of claim 1, wherein the synchronization circuitry is configured to determine a resource status value and a generation number based on the monitoring of the first instruction-handling circuitry and the second instruction-handling circuitry, and wherein the selectively delaying delivery of one of the first instructions or one of the second instructions is based on the resource status value and the generation number.

16. The system of claim 1, wherein the first instruction-handling circuitry comprises an interconnect fabric and the second instruction-handling circuitry comprises an instruction pipeline.

17. A method for synchronizing instructions between a processor and a coprocessor, comprising:
generating, by a processor, first instructions of a first instruction type and second instructions of a second instruction type;
transmitting the first instructions from the processor to a coprocessor via first instruction-handling circuitry;
transmitting the second instructions from the processor to the coprocessor via second instruction-handling circuitry;
monitoring, by synchronization circuitry, the first instruction-handling circuitry and the second instruction-handling circuitry;
controlling, by the synchronization circuitry and based on the monitoring, first stall circuitry and second stall circuitry, the first stall circuitry being located between the first instruction-handling circuitry and the coprocessor and the second stall circuitry being located between the second instruction-handling circuitry and the coprocessor, wherein delivery of one of the first instructions is selectively delayed at the first stall circuitry or delivery of one of the second instructions is selectively delayed at the second stall circuitry; and
performing, by the coprocessor, a first operation for the one of the first instructions and a second operation for the one of the second instructions, wherein an order of performing the first operation and performing the second operation is based on the controlling of the first stall circuitry and the second stall circuitry.

18. The method of claim 17, wherein:
the first instruction type is a memory access instruction type; and
the second instruction type is a computational instruction type.

19. A system for synchronizing instructions between a first processor and a second processor, comprising:
a first instruction-handling circuitry within a first transmission path between a first processor and a second processor, wherein a first instruction is transmitted via the first instruction-handling circuitry;
a second instruction-handling circuitry within a second transmission path between the first processor and the second processor, wherein a second instruction is transmitted via the second instruction-handling circuitry;
first stall circuitry located between the first instruction-handling circuitry and the second processor;
second stall circuitry located between the second instruction-handling circuitry and the second processor; and
synchronization circuitry coupled to monitor the first instruction-handling circuitry and the second instruction-handling circuitry and to control the first stall circuitry and the second stall circuitry, wherein the synchronization circuitry is configured to selectively delay delivery of the first instruction at the first stall circuitry or the second instruction at the second stall circuitry based on the monitoring of the first instruction-handling circuitry and the second instruction-handling circuitry.

20. The system of claim 19, wherein:
the first instruction is a memory access instruction; and
the second instruction is a computational instruction.
